(19) United States
(12) Patent Application Publication
(10) Pub. No.: US 2003/0010179 A1
(43) Pub. Date: Jan. 16, 2003

(54) Splinterless sawblade

(76) Inventor: Carl T. McLuen, Sequim, WA (US)

Correspondence Address: CARL T. MCLUEN, 455 WOODCOCK ROAD, SEQUIM, WA, 98382, US

(21) Appl. No.: 09/931,533

(22) Filed: Aug. 17, 2001

Related U.S. Application Data
(60) Provisional application No. 60/305,579, filed on Jul. 16, 2001.

(51) Int. Cl. B27B 33/00

(52) U.S. Cl. 83/848; 83/835

(57) ABSTRACT

A reciprocating (saber) saw blade having normal cutting teeth for most of its working length from the tip towards the connection end.

Opposed downward cutting teeth extend the remainder of the working length, and are angled forward in the direction of the cut. These downward cutting teeth cut a wedge-shaped notch in the workpiece at the end of the downward blade stroke. This notch enables the subsequent upward cutting stroke to progress forward without splintering surface fibers

### BACKGROUND

1. Field of Invention

This invention relates to saw blades such as are used in reciprocating (saber) saws.

1. Prior Art

Development of hand held reciprocating saws has enabled cutting of contours and shapes in flat materials such as plywood, wafer board, and masonite. Most such saws use blades which cut on the upstroke wherein the saw blade is retracted into the saw. This causes much splintering and fraying of the top surface of the material. Cutting to a line is difficult as the line is lost, or obscured, by the splintering. The splintered material protruding above the work surface impedes forward movement of saw footplate, and prevents smooth forward movement of the saw.

To reduce such splintering, fine tooth blades can be used, but are very slow cutting. Certain blades which cut downward are used to cut sheets surfaced with thin plastic laminate. They do not splinter at the top, but cut very slowly, and do splinter the bottom side of the sheet. Some saber saws have an optional device, which presses down on the workpiece beside the cutting blade, to reduce splintering. This, of course, obscures any guide lines drawn on the workpiece.

The Objects and Advantages of this Invention:

The saw blades described in this patent will allow rapid sawing of plywood and similar sheet material, without degradation of surfaces adjacent to the cut. Patterns marked on the workpiece remain visible. Absence of splinters enables smooth passage of the saw along the cut path. This blade is adaptable to all makes of such saws. No complex or difficult manufacturing processes are required to to make these blades. This blade is also useful in crosscutting fir, pine, and other woods which tend to splinter.

### DRAWINGS

A Brief Description of the Drawing Figures:

FIG. 1. A top view of the preferred embodiment.

FIG. 2. A side view of the preferred embodiment with saw footplate and workpiece shown in phantom view.

FIG. 3: A top view of an alternate embodiment with chisel shaped notching teeth.

FIG. 4. A side view of the alternate embodiment.

FIG. 5a and 5b. Section views through the notching teeth shown in FIG. 4.

FIG. 6. A perspective sketch of the notching teeth of the alternate embodiment.

Reference numbers in drawings:

10. Downward cutting (notching) teeth in the preferred saw blade embodiment.

11. Normal upward cutting saw teeth.

12. Saber saw footplate position (phantom view) at full down stroke.

13. Section of a work piece (phantom view).

14. Saw blade position shown at maximum downward (extend) stroke.

15. Chisel notching teeth of an alternate embodiment.

### DETAILED DESCRIPTION OF THE PREFERRED EMBODIMENT

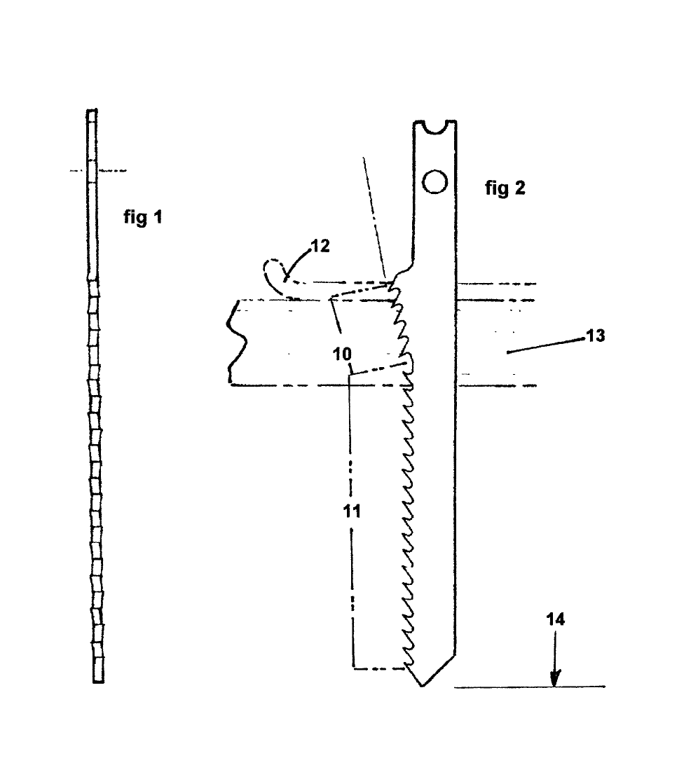

The preferred embodiment of this invention is shown in FIGS. 1 and 2. The cutting teeth 11 have the usual alternate set left and right, as shown in FIG. 1. The downward cutting teeth 10 are similar except inverted to cut on the downward stroke. These teeth are the same height as the upward cutting teeth, where they are adjacent, but angle outward to the left as shown to form a wedge shape. In FIG. 2, the saw blade is shown at its maximum down stroke position 14 relative to the footplate 12 of the saber saw, and the notching teeth have penetrated a short way into the workpiece 13.

These downward cutting teeth are also set left and right, and serve to sever the top fibers of the plywood or other material being cut. As a result, such fibers are removed cleanly on the next upward cut, and no splintering of the surface occurs.

Addition Embodiments;

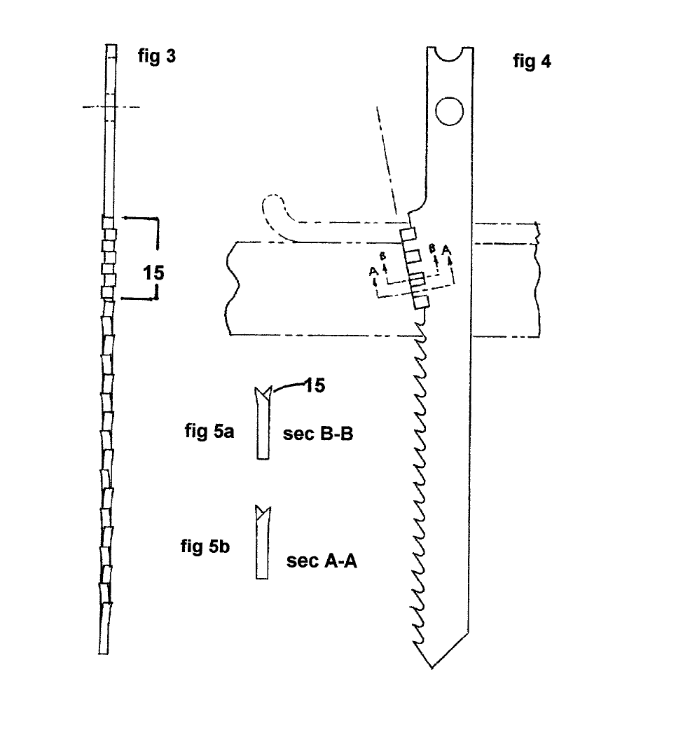

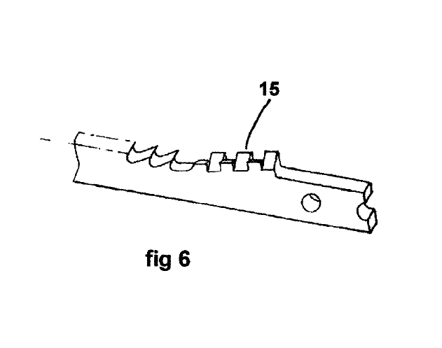

An addition embodiment shown in FIGS. 3, 4, 5a, 5b, and 6 employs chisel shaped teeth to notch the surface of the work piece. In this embodiment, the chisel teeth 15 are formed at the aft end of the working portion of the saw blade as shown in FIGS. 3 and 4. These chisel shaped teeth alternate to left and right, and serve to notch out the work piece at the edges of the blade on the last segment of the downward stroke. On the subsequent upward stroke, the normal upward cutting teeth progress through this notch without splintering surface fibers. FIGS. 5a, 5b, and FIG. 6 show the chisel shaped notching teeth in this embodiment.

Other configurations in work, but not yet tested, include variations in mount details to accommodate some saw models by Porter-Cable, Black and Decker, and Bosch. Variations in the means of notching the surface of the workpiece are also being evaluated.

Advantages:

1. A primary advantage of this invention is the ability to cut plywood, wafer board, and other fibrous sheets without splintering the edges of the cut.

2. The splinterless operation is also an advantage when cutting across the grain of dimensional boards.

3. This saw blade enables cutting at the edges of pencil lines on the workpiece. Such lines are visible during and after the cutting operation.

4. Larger than usual saw teeth can be used on this saw blade so that fast cuts can be made without splintering problems.

5. The absence of splinters at the surface of the work piece enables smooth forward movement of the saw.

6. No exotic or unusual saw teeth are required, so that normal saw blade manufacturing methods can be used.

7. A greater proportional length of downward cutting teeth 2 can be useful in rapid cutting of thicker material.

Operation:

Operation of a saw equipped with his splinterless blade is the same as that with any general purpose saw blade. However, coarser blades with fewer teeth per inch may be used for cutting most materials. Saws which have provision to blow aside surface sawdust are most suitable for precision work with this saw blade. No unusual stroke rates, or cutting rates are required.

Conclusions, Ramifications, and Scope:

This saw blade is simple in concept, but solves a long-standing problem in the use of saber saws. Blades have been made and tested to verify the basic embodiment. Both thick and thin blades can be made to be splinterless by use of this patent. Other tooth configurations can be envisioned by those skilled in the art, which can serve as the means for notching the work piece as defined in claims stated herein, and are considered to be encompassed by this patent.

claims:

1) A reciprocating saw blade comprising
(a) a saw blade attachable to a reciprocating (saber) saw, with primary cutting teeth angled and set to cut on the upward stroke of the saw, and
(b) means for notching or cutting the top surface of the workpiece prior to each upward stroke of the saw, and in the direction of the saw cut.

2) A saw blade as in claim 1 above, wherein the means for notching the top of the work piece are saw teeth oriented to cut on the downward stroke of the saw, and
(a) are located near the heel of the saw blade so as to protrude beyond the footplate of the saw when the blade is fully extended downward, and
(b) are angled outward from other saw teeth on the blade to cut a wedge-shaped notch in the top surface of the work piece ahead of the main body of the blade.

3) A saw blade as in claim 1 above, wherein the means for notching the top surface of the work piece are chisel shaped teeth in line with the main axis of the saw blade, and
(a) have sharpened edges on alternate sides of the blade, and
(b) are angled as in claim 2(b) above, to cut a notch wider than the saw blade, in the surface of the workpiece., ahead of the blade, in the direction of the saw cut.
